(19) United States
(12) Patent Application Publication
(10) Pub. No.: US 2016/0190607 A1
(43) Pub. Date: Jun. 30, 2016

(54) ELECTROCHEMICAL CELL

(71) Applicant: Wyon AG, Appenzell Steinegg (CH)

(72) Inventors: Paul WYSER, Appenzell (CH); Philipp WYSER, Appenzell (CH)

(73) Assignee: Wyon AG, Appenzell Steinegg (CH)

(21) Appl. No.: 14/875,839

(22) Filed: Oct. 6, 2015

(30) Foreign Application Priority Data
Dec. 29, 2014 (EP) 14 004 430.6

(51) Int. Cl. H01M 6/02; H01M 2/08; H01M 2/02

(52) U.S. Cl. CPC H01M 6/02; H01M 2/0222; H01M 2/08; H01M 2220/30

(57) ABSTRACT

The present invention concerns an electrochemical cell of a layered electrode structure, oppositely poled electrode layers being arranged such that they are physically kept at a distance from one another by separator layers. The cells comprise a first housing part, which defines an interior volume and is designed in such a way that at the same time it forms an output conductor for a first electrode pole. It also comprises a pin, which extends from the outside into the interior volume and is designed in such a way that it forms an output conductor for a second electrode pole. The cell according to the invention also comprises an insulation, which insulates the first housing part electrically from the pin, and the electrode layers in the interior volume being in physical contact with their corresponding output conductors in such a way that there is a mechanical pretensioning between the electrode layers and the corresponding output conductor. The present invention also concerns a method for producing an electrochemical cell according to the invention, and also corresponding uses of the same.

### TECHNICAL FIELD

The present invention concerns an electrochemical cell with a layered electrode structure. It also concerns methods for producing an electrochemical cell with a layered electrode structure, and the use of said cell, all according to the preambles of the independent claims.

### PRIOR ART

Electrochemical cells serve for the conversion of chemical energy into electrical energy. Electrochemical cells are used inter alia as batteries, in order to operate electrical loads independently of a power supply system over a certain period of time. For small portable or stationary devices, such as for example hearing aids, with a high energy demand, primary zinc/air cells in the form of button cells are used. On average, these batteries have to be replaced every five to ten days. Particularly for batteries that are intended for hearing aids or implants, size plays a decisive part. Such batteries are usually designed as button cells. The generally cylindrical flat “button-shaped” batteries are also used in watches, flashlights, cameras, thermometers, etc. Apart from the already mentioned primary zinc/air cell, button cells may be designed as a lithium-ion or zinc/silver-oxide battery.

The electrodes in small batteries suitable for miniaturization are often layered, with positive and negative electrodes alternating in the layer structure.

An example of a battery of a wound structure is shown in U.S. Pat. No. 7,294,430 B2 (Wyon A G, CH). Shown there is a wound electrode arrangement, the conductive charge of which is drawn off through a pin structure extending through the entire housing. In principle, the battery shown is intended to make the most efficient possible use of the active volume available, that is to say the interior space of the cell.

WO 2014/072494 A1 (Varta Microbattery GmbH) likewise shows a button cell with an electrode coil. The conductive charge is drawn off directly by way of a two-part housing, in which the housing parts, each of opposite polarity, are electrically separated from one another. In order to save space, the inner current output conductors are placed down on the iron side of the electrode coils by being turned down. When the coil becomes swollen as electrolyte is added, a clamping process takes place. It is consequently possible in this document to dispense with welding of the output conductors to the corresponding main part of the housing. However, the inner output conductors take up considerable space, and valuable active volume is lost.

Furthermore, the wound structure is disadvantageous in the case of overall sizes below a certain size because of the loss of active volume resulting from the coils.

There is a fundamental need for electrochemical cells that have the greatest possible active volume, that is to say as far as possible use the entire available interior volume with active material. With preference, a battery should also be suitable for particularly small overall heights, in order to be able to be fitted in implants, hearing aids, insulin dispensers and the like.

It is consequently an object of the present invention to overcome at least one disadvantage of the known art. In particular, it is intended to provide an electrochemical cell that has the highest possible energy density, or has the highest possible proportion of active volume, and that can at the same time be produced efficiently and reliably. It is also intended in particular to provide a method for producing an electrochemical cell that can produce an electrochemical cell mentioned at the beginning inexpensively and efficiently.

### SUMMARY OF THE INVENTION

The way in which at least one of the objects mentioned is achieved is defined by the characterizing part of the independent claims.

One aspect of the present invention concerns an electrochemical cell of a layered electrode structure.

In a particular embodiment, this is a button cell, as described at the beginning. In principle, a button cell has a flat, button-shaped form and has a diameter of between 5 and 50 mm, with thicknesses of between 1 and 5 mm. In principle, however, the electrochemical cell according to the invention may also be a battery departing from the button cell form. Alternative forms of construction, such as for example horseshoe or toroidal batteries, may be used in certain implants or particular medical devices. The electrochemical cell according to the invention has a layered electrode structure, oppositely poled electrode layers respectively being arranged such that they are physically separated from one another by separator layers. This arrangement may be understood as a layered structure in which oppositely poled electrode layers are placed alternately one over the other with separator layers interposed in between.

The electrochemical cell according to the invention also comprises a first housing part, which defines an interior volume and at the same time is designed in such a way that it forms an output conductor for a first electrode pole.

The cell according to the invention also comprises a pin, which extends from the outside into the interior volume and is designed in such a way that it forms an output conductor for a second electrode pole. The cell also comprises an insulation, which insulates the first housing part electrically from the pin. The electrode layers are arranged in the interior volume with their corresponding output conductors in such a way that they are in physical contact and that there is a mechanical tensioning between the electrode layers and the corresponding output conductor.

The electrochemical cell of the present invention may be both a secondary cell and a primary cell.

For the purposes of the present invention, the positive pole is for example the opposite pole of the negative pole, and vice versa. However, the polarity of the corresponding electrodes in the architecture according to the invention is of secondary importance for carrying out the present invention. That is to say that, for the purposes of the present invention, both the cathode and the anode may be in physical contact with the first housing part as an output conductor. All that matters is that there is a mechanical tensioning between the electrode layers and their respective output conductor assigned to a certain polarity.

For the purposes of the present invention, “outside” is to be understood in relation to the interior volume of the battery, which in turn is defined by a volume that is determined by the form of the first housing part. In a particular embodiment, therefore, the first housing part has a substantially cup-shaped form. In this example, the interior volume is defined as the volume of the cup. Outside the electrochemical cell is therefore everything that would have to penetrate through a housing wall or a cover to get into the interior volume in the case of a ready-assembled and sealed cell.

In one particular embodiment, the output conductors at the same time form the poles of the electrochemical cell. This means in principle that there is an output conductor respectively for the positive pole and for the negative pole.

A mechanical tensioning such as that which the electrochemical cell according to the invention has is a tensioning that is introduced during production. This may be produced by components that undergo a deforming process during assembly being provided on the structural parts concerned. The mechanical tensioning may in this case be caused by the corresponding components reverting to their original form when the mechanical tensioning is no longer present.

In a particular embodiment, these components are made of a material that has the corresponding elastic properties.

The mechanical pretensioning makes particularly space-saving contacting of the electrodes with their respective output conductors possible. This arrangement makes it possible to dispense with additional output conductor lugs in the interior volume of the electrochemical cell. The contacting of the electrodes with their output conductors takes place directly.

In a particular embodiment, tabs which protrude beyond the areal extent of the interior volume are formed on the electrode layers. With preference, they protrude beyond the areal extent of the interior volume in the direction of the respective output conductor with which the corresponding electrode layer is in physical contact. In this sense, the areal extent of the interior volume should be understood as meaning the areal extent that is in the same plane as the electrode layers.

In a particularly preferred embodiment, a deformation of the tabs formed on the electrode layers in the assembled state is responsible for the mechanical tensioning mentioned. The tabs may be produced from a material that has the required elasticity to change its form under the effect of force during assembly and to produce a corresponding mechanical tensioning with respect to the output conductor. Materials that have this elastic deformability may be, inter alia, metals, metal alloys and/or plastics. In a particularly preferred embodiment, these tabs consist of a carrier material for the electrodes. Thus, for example, a tab of an anode layer may be fashioned by a lengthening of a copper carrier in the areal extent toward the respective output conductor. By analogy, for the cathode, the tab may be formed by a lengthening of an aluminum carrier of the electrode toward the corresponding output conductor.

The electrodes may be provided with all commonly used coatings, which may be selected by a person skilled in the art with respect to the intended use. Commonly used electrode materials are lithium-cobalt oxide (LiCoO₂), lithium-manganese oxide (LiMn₂O₄), lithium-iron phosphate (LiFePO₄), lithium-nickel-manganese-cobalt oxide (LiNiMnCoO₂) or lithium-nickel-cobalt-aluminum oxide (LiNiCoAlO₂). In a particular embodiment, the tabs themselves are free from electrode material; with preference, the electrode material has been ablated by means of a laser. In a particular embodiment, the areal extent of the interior volume has a diameter D, which at the same time forms an inside diameter of the interior volume. A first electrode is in physical contact with the first housing part as an output conductor and has an outside diameter D_{L}, which is greater than the inside diameter D. As a result of this overhang, a deformation of the outer border of the electrode layer takes place when placing the electrode layer in the interior volume of the electrochemical cell, and a mechanical pretensioning is produced, ensuring reliable and constant contacting of the electrode layer with its respective output conductor, in this case the housing wall. With preference, the outside diameter of the electrode layer is greater than the inside diameter by 0.02 to 1.5 mm. With particular preference, the outside diameter of the electrode layer is greater than the inside diameter of the interior volume by 0.04 to 0.1 mm.

This embodiment concerns electrochemical cells of the button cell form that are of a substantially circular design. In the case of forms that depart from this button cell form, it is decisive that the areal extent of the electrode layer is greater than the areal extent of an interior volume in the same plane as the electrode layer. In principle, the outside diameter may exceed the inside diameter by a certain percentage. The outside diameter of the electrode layer is preferably greater than the inside diameter of the housing part by between 0.45 and 2.5%. With particular preference, the outside diameter of the electrode layer is between 0.5 and 1% greater than the inside diameter of the housing part.

In a particular embodiment, a coating of an electrode layer ends at an outside diameter that is smaller than the outside diameter of the electrode layer. With preference, a tab that is formed by the electrode layer is consequently not coated.

In a particular embodiment, the coating ends at a diameter D_{b}, which is smaller than the inside diameter D of the housing part. With particular preference, the coating ends at a diameter which is smaller than the inside diameter of the housing part by between 0.05 and 0.5 mm. With particular preference, the second diameter D_{b} ends at a diameter which is smaller than the inside diameter D of the housing part by between 0.1 and 0.3 mm. Consequently, by analogy with the embodiment described above, in the case of a round electrochemical cell there occurs an entirely non-coated outer periphery of an electrode layer, which extends around it like a border. Inter alia, this border forms the tab that is capable of mechanically pretensioning the electrode layer with its output conductor, that is to say the housing part. With preference, this tab is formed as a band in the periphery of an electrode layer with a width of between 0.15 and 0.4 mm.

In a particular embodiment, this band is altogether between 0.5 and 2.2% of the outside diameter of the electrode layer.

In a particular embodiment, the pin is designed as a central output conductor shaft. In particular in the case of circular button cells, the central output conductor shaft then runs in the longitudinal direction through the center point of the circle of the circular button cell.

In a particular embodiment, the central output conductor shaft is designed in such a way that it extends through clearances in all the electrode layers of the entire interior volume. In the case of a circular button cell, the electrode layers are likewise of a circular design. In order to accommodate the central output conductor shaft, the circular electrode layers have correspondingly proportioned clearances around their center point. One over the other, the layers consequently form an empty volume that can receive the central output conductor shaft. In this embodiment, electrode layers of a certain polarity are ideally designed in such a way that they physically contact the central output conductor shaft. With preference, the electrode layers of the opposite polarity are designed in such a way that they are kept at a distance from the central output conductor shaft.

In a particularly preferred embodiment, this distance is at least 0.1 mm, preferably at least 0.2 mm, with particular preference at least 0.23 mm.

In a particular embodiment, a first electrode layer comprises a first clearance. Through this clearance there extends the pin, in particular perpendicularly. The first clearance has a first diameter, which is greater than the outside diameter of the pin. Here and hereinafter, the outside diameter of the pin should be understood as meaning the diameter that defines a sectional plane through the pin in the areal extent in which the electrode layer concerned is located. In this present example, this sectional plane, and consequently the outside diameter, would be required to be considered in a plane running perpendicularly in relation to the linear extent of the pin. With preference, this first diameter is greater than the outside diameter of the pin by between 0.2 and 1.6 mm; with particular preference, this first diameter is greater than the outside diameter of the pin by between 0.4 and 0.8 mm. With particular preference, the outside diameter of the clearance is greater than the outside diameter of the pin in said sectional plane by 50 to 100%.

In a particular embodiment, a second electrode layer is in physical contact with the pin as an output conductor. Said second electrode layer has a second clearance, through which the pin extends in a way similar to that described in the aforementioned embodiment. This second clearance has a second diameter, this second diameter being smaller than the outside diameter of the pin. With preference, this second diameter is smaller than the outside diameter of the pin by between 0.25 and 3 mm. With particular preference, the second diameter of the second clearance is smaller than the outside diameter of the pin by 0.05 to 0.15 mm. This may have the effect in the assembled state that, when the pin is pushed into the corresponding clearance, all of the electrode layers of a certain polarity are displaced by the pin by this difference in size by which their clearances are smaller than the outside diameter of the pin. This produces a physical contact between these electrode layers and the pin.

In a particular embodiment, the difference in size of the electrode layer with the smaller diameter of the clearance than the diameter of the pin has the effect of forming a tab by which this second electrode layer establishes an electrically conducting contact with the pin.

In a particular embodiment, an electrode layer is substantially enclosed by a separator layer. For the purposes of the present application, “substantially enclosed” should be understood as meaning that the electrode layer is insulated from the oppositely poled electrode layer by the enclosure sufficiently to prevent a short-circuit. In particular, a cathode layer is arranged between two separator layers welded to one another. In this case, the separator layers may be designed like a bag in which the cathode layer can be received. With preference, the separator layers that substantially enclose a cathode layer are connected to one another in a material-bonded manner. The separator layers may be arranged in such a way that they are open on a side facing the corresponding output conductor of a certain polarity of the electrode layer concerned, while they are closed on the averted side, that is to say with regard to the side facing the output conductor of the opposite polarity. A material-bonded connection between two separator layers can be accomplished by welding of the separator layers. This welding may be accomplished as a continuous weld seam around an overhanging edge of the separator layers, or by means of discrete weld seams. Such welded separator layers are shown for example in EP 2 406 592 A1. The separator layers preferably consist of ion-conducting film.

In a particular embodiment, the electrode layers are arranged in the housing part in such a way that they have a mechanical pretensioning with respect to their respective output conductor.

In a particular embodiment, the electrochemical cell according to the invention also has a housing cover with a clearance for receiving the pin. This cover is designed in such a way that the pin can extend from the outside into the interior volume of the electrochemical cell.

In a particular embodiment, the outer-lying part of the pin forms an output conductor pole of the ready-closed battery. In this embodiment, the electrochemical cell also comprises at least one seal between the housing part and the housing cover and/or the housing cover and the pin. This seal seals the electrochemical cell from the outside. With preference, the electrochemical cell is sealed in a gastight manner. With particular preference, this seal comprises a glass seal. Alternatively, this seal may also be produced as a sealing ring made of plastic. Alternatively, the seal may comprise a metal oxide layer, in particular a ceramic metal oxide layer such as for example Al₂O₃.

In a particularly preferred embodiment, this seal is mounted between the housing cover and the pin. It insulates these two elements from one another. The structure of the electrochemical cell according to the invention makes it possible to design the sealing ring to be comparatively small, to be specific around the central output conductor pin. In the prior art, the sealing rings are generally between the housing part and the housing cover, and are consequently comparatively greater in diameter than the closely fitting sealing rings that are possible according to the present invention. This allows the structure of the battery and the utilization of the active volume to be improved further. In the present embodiment, the housing part and the housing cover may be connected in a material-bonded manner, in particular welded.

In a particular embodiment, the pin comprises a flange. The clearance in the housing cover is then designed in such a way that there is a form fit between the flange and the housing cover. In the assembled state, the flange prevents the pin from coming out of the battery.

In preassembly, it is thus possible inter alia to fit the battery with a mechanical pretensioning. For this purpose, a base opposite from the housing cover is provided with a concave base area or a central elevation. The pin and the housing cover are preassembled, in that the pin with the flange is brought into form-fitting contact with the clearance with a corresponding shoulder of the housing cover. The pin with the housing cover is then pressed into the first housing part in such a way that there is a mechanical tensioning between the concave or indented housing base and the housing cover with the output conductor pin. As a sealed electrochemical cell, the battery welded between the housing part and the housing cover then has a mechanical pretensioning.

In a particular embodiment, the pin is made up of various components. With preference, the pin comprises multiple pieces. The output conductor pin may for example be made up of two different materials that are pressed together. In a particularly preferred embodiment, the pin consists of a first material, which extends through the clearances in the electrode layers in the interior volume of the cell, and a second material, which extends outward from the interior volume through the housing cover. The two materials are connected to one another in a conducting manner. With preference, the second material is a solderable material; with particular preference, the second material is gilded copper. With preference, the first material is made of the same material as the electrode layers contacted correspondingly for drawing off conductive charge, that is to say for example of aluminum or copper.

In a particular embodiment, a housing base of the housing part that is arranged opposite from the housing cover is consequently of a concave form. For the purposes of this feature, concave relates to the outside perspective of the electrochemical cell according to the invention.

In a particular embodiment, the cell comprises a nonwoven material. The nonwoven material may be provided with swelling properties, which ensure that, after adding an electrolyte, a mechanical pretensioning is maintained in the interior volume of the electrochemical cell. Furthermore, in a particular embodiment, the nonwoven material may be laid out on the housing base. This housing base may be arranged opposite from the housing cover. This allows the nonwoven material to insulate the interior of the electrochemical cell, in particular the pin, electrically with respect to the housing base.

For a person skilled in the art, it goes without saying that the particular embodiments mentioned may be realized in an electrochemical cell according to the invention in any desired combination with one another, as long as they are not mutually exclusive.

A further aspect of the present invention concerns a method for producing an electrochemical cell, in particular an electrochemical cell according to the invention described at the beginning. This method comprises the step of alternately placing oppositely poled electrode layers in a first housing part, which defines an interior volume of the electrochemical cell. With preference, the electrode layers are placed alternately with separator layers. That is to say for example that a cathode layer is followed by a separator layer, which in turn is followed by an anode layer and a further separator layer. It is also possible in this step to place preassembled sequences of layers in the housing part in a single step. That is to say that the electrode layers may be pre-layered.

In a particular embodiment, the electrode layers are previously welded in between two separator layers. The method according to the invention also comprises the step of pretensioning a first electrode layer with regard to the inner wall of the first housing part. This pretensioning is a mechanical pretensioning, which takes place by the diameter of this electrode layer being greater than the inside diameter of the first housing part. With preference, an uncoated outside diameter of this electrode layer is formed as a tab that physically contacts the inner wall of the first housing part. The method according to the invention also comprises the step of filling with an electrolyte medium. The method according to the invention also comprises the step of closing the electrochemical cell with a housing cover. In this case, a pin is led through a clearance in the housing cover and extends into the interior volume of the electrochemical cell. This takes place in such a way that a pretensioning is produced between the pin and a second electrode layer. This is ensured by the clearance for receiving the pin of this second electrode layer having a diameter that is smaller than the outside diameter of the pin. With preference, the diameter of this second electrode layer, which surrounds the clearance, is a non-coated lengthening of the electrode layer that is formed as a tab and physically contacts the output conductor pin.

In this document, for the sake of simplicity reference is made in each case to an electrode layer; however, for a person skilled in the art it goes without saying that this may be taken as meaning a series of electrode layers fitted one above the other. With preference, between eight and ten electrode layers of a certain polarity, that is to say altogether between 16 and 20 electrode layers, are fitted in an electrochemical cell as in the method described above.

In a preferred embodiment, tabs are formed on the electrode layers, in order as mentioned above to tension the electrode layers with regard to their respective output conductor.

In a particular embodiment, the electrode layers are formed by cathode layers and anode layers. A cathode layer and/or an anode layer is in this case previously placed between two separator layers and the separator layers are connected in a material-bonded manner, in particular welded, at at least one location, in particular at a plurality of locations.

In a particular embodiment, the method according to the invention also comprises the following step: the housing cover and the pin are preassembled, in that a sealing ring coated with a sealing compound is pressed in at a clearance in the housing cover and the pin is led through the clearance, so that it is pressed with a flange of the pin against the sealing ring.

In a particular embodiment, the method according to the invention also comprises the step of placing a nonwoven material in the first housing part.

In a particular embodiment, the nonwoven material is placed on a housing base of the housing part before the electrode layers are placed in.

For a person skilled in the art, it goes without saying that the present invention may comprise further method steps that could be required in order to realize the aforementioned particular embodiments of the electrochemical cell.

A further aspect of the present invention concerns the use of an electrochemical cell, as described at the beginning, as a battery in a hearing aid. In this case, the electrochemical cell is mounted directly on an electrical circuit board of the hearing aid. In the case of the battery according to the invention, the output conductors of the electrochemical cell are designed as integral component parts of the outer housing. Thus, the first housing part serves as the first output conductor and the pin extending outward from the interior volume serves as the second output conductor. These conductors may be designed with rivets, soldering points or elevations in such a way that they can be fastened directly to a corresponding circuit board for energy output.

These structures on the housing surface may serve as output conductor lugs for the electrochemical cell from the outside.

A further aspect of the present invention concerns the use of an electrochemical cell according to the invention as a battery in an implant, in particular in a cardiac pacemaker. In this case, by analogy with the aforementioned use, the electrochemical cell is mounted directly on a circuit board.

All of the particular embodiments of the electrochemical cell or of the method for the production thereof can be combined in any way desired within the scope of the present invention, as long as they are not mutually exclusive.

The invention is explained more specifically below on the basis of actual exemplary embodiments and detailed descriptions, without however being restricted by these. Otherwise, further advantageous embodiments and combinations of features of the present invention emerge from this detailed description and the patent claims as a whole.

### BRIEF DESCRIPTION OF THE DRAWINGS

The drawings used for explaining the exemplary embodiments schematically show:

FIG. 1 an electrochemical cell according to the invention, which is assembled on a circuit board;

FIG. 2 an electrochemical cell according to the invention, designed as a button cell, in cross section;

FIG. 2A the physical contacting of the output conductor by means of tabs;

FIG. 2B the physical contacting of the second output conductor by means of tabs;

FIG. 2C the welding location between the housing cover and the housing part;

FIG. 3A the preassembled housing cover with the pin;

FIG. 3B the cup-shaped housing part with the electrode filling;

FIG. 4 an anode layer with tabs on the outer periphery;

FIG. 5 a cathode layer with tabs on the inner periphery of the central clearance;

FIG. 6 a two-part output conductor pin.

In principle, the same parts are provided with the same reference signs in the figures.

WAYS OF CARRYING OUT THE INVENTION

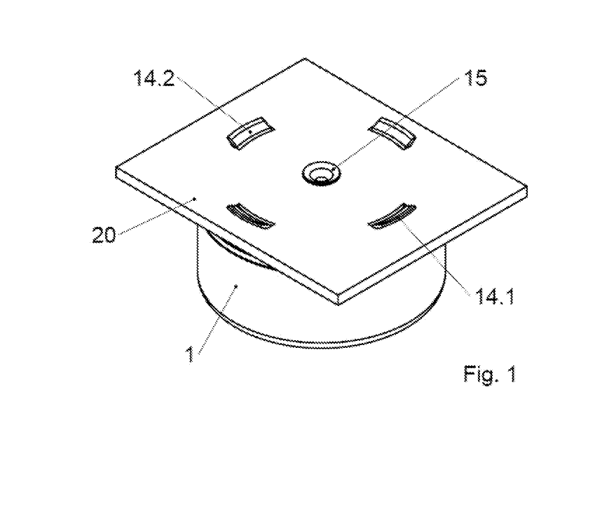

FIG. 1 schematically shows from the outside an electrochemical cell according to the invention, which has been assembled on a circuit board 20. The electrochemical cell 1 is designed substantially in the form of a button and has output conductor lugs for the anode 14.1, 14.2 and output conductor lugs for the cathode 15. In this example, the output conductor lugs 14.1, 14.2, 15 have been inserted into prefabricated rivets of the circuit board. However, it would likewise be conceivable to design the output conductor lugs 14.1, 14.2, 15 in such a way that they are suitable for a soldering process on the circuit board.

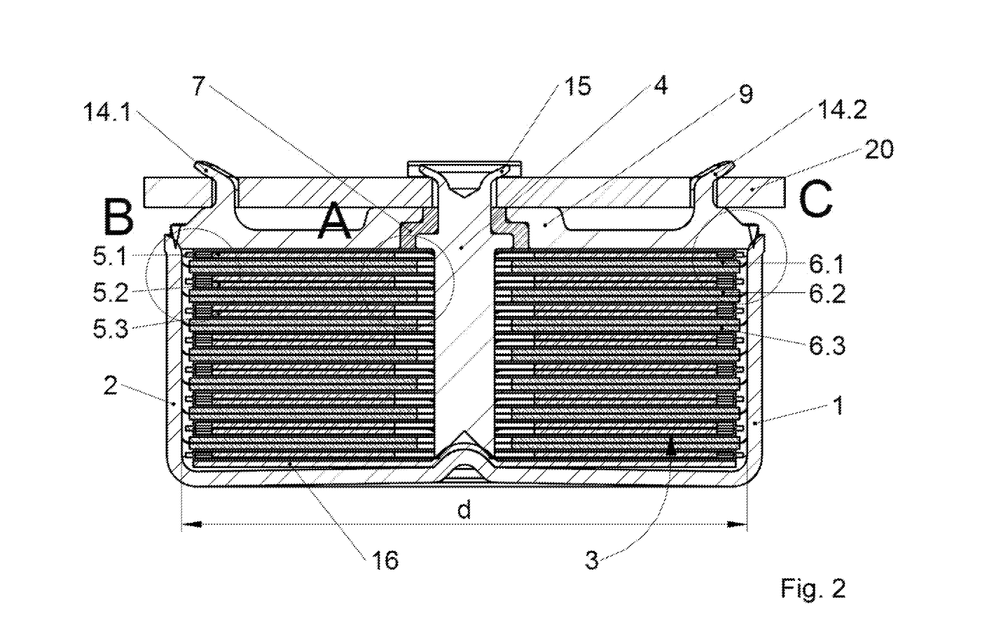

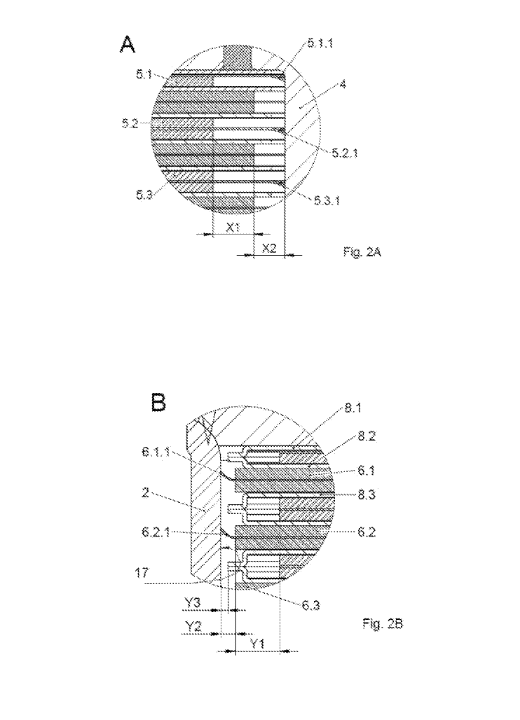

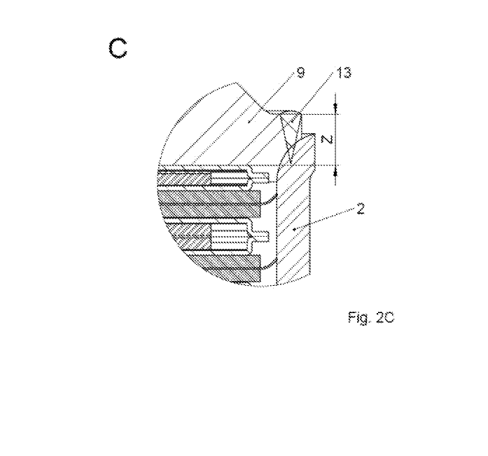

FIG. 2 shows by way of example the electrochemical cell 1 mounted on the circuit board 20 in cross section. The electrochemical cell 1 has a substantially cup-shaped first housing part 2 made of copper. Likewise suitable would be, inter alia, gilded copper, stainless steel or some other material suitable for glass bushings, such as for example titanium.

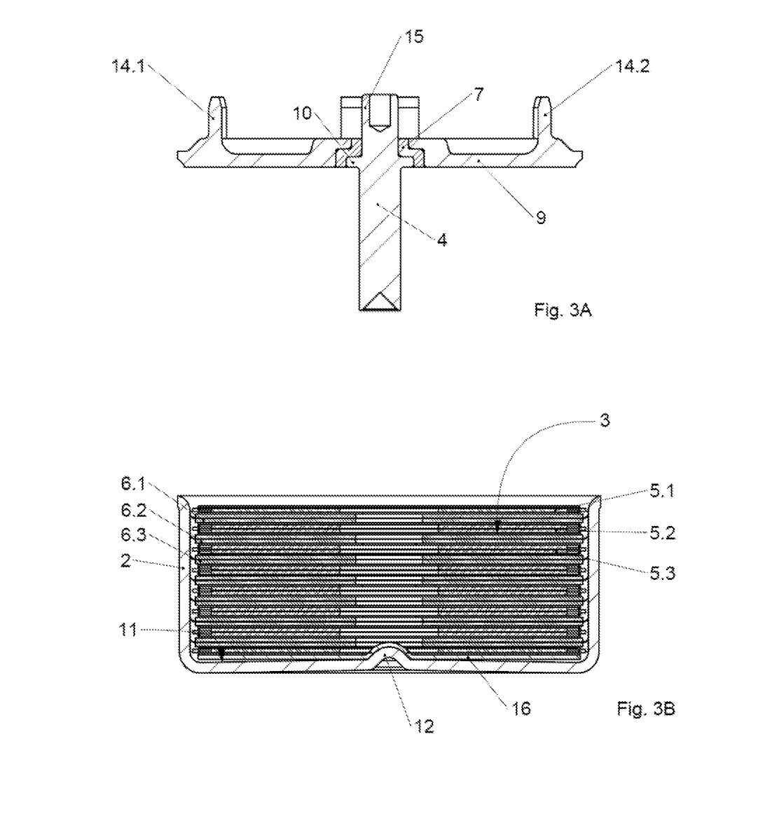

The housing part has a diameter D and defines an interior volume 3. The diameter D corresponds to the diameter in the areal extent in which the electrode layers are located, less the housing thickness of the housing part 2. In the present example, a housing thickness of 0.2 mm has been provided. The inside diameter D of the electrochemical cell shown by way of example is 7.5 mm. The housing part 2 is connected in a material-bonded manner to a housing cover 9. A more detailed representation of this material-bonded connection is explained more specifically in FIG. 2C, below. The housing cover 9 consists of a material that is compatible with the housing part, in the present example likewise of copper, gilded copper or stainless steel. Through the housing part 9 there extends an output conductor pin 4 into the interior volume 3 of the housing part 2. The output conductor pin 4 is led through a clearance in the housing cover 9 and electrically insulated with respect to the latter. Provided for this purpose is a sealing ring 7, which is coated with a sealing compound. The sealing ring 7 is first pressed into the housing cover 9, and the output conductor pin 4 is subsequently pressed into the sealing ring 7. The output conductor lug 15, formed in one piece by the output conductor pin, protrudes from a corresponding opening in the circuit board and is bent for the fixing of the electrochemical cell. In the preassembled state, however, the output conductor pin 15 is not bent, which is explained in more detail in FIG. 3A, below. In the present example, the sealing ring is made of a polypropylene plastic. Alternatively, the sealing ring may however also be made of, inter alia, glass or a polyether ketone. In the present example, the output conductor pin is made of aluminum. Stainless steel or a material that is suitable for glass bushings would likewise be suitable.

In the housing base opposite from the housing cover 9, a nonwoven material 16 has been placed. In the present example, the nonwoven material is a polypropylene nonwoven. However, a Teflon nonwoven would likewise be suitable. This nonwoven produces a slight mechanical pretensioning for the electrode stack. This allows continuous good ionic conductivity to be ensured, in spite of any expansion and shrinkage of the heights of the stack during the charging and discharging processes. The nonwoven 16 consequently forms a cushion with a spring effect. As an additional advantage, the nonwoven material 16 may also provide insulation with respect to the housing part 2. In particular, the nonwoven material 16 may insulate the output conductor pin 4 with regard to the housing part 2.

In the interior volume 3 of the housing part 2, electrode layers are placed in an alternating stacking manner. In this case, cathode layers 5.1, 5.2, 5.3, . . . alternate with anode layers 6.1, 6.2, 6.3, . . . . The oppositely poled electrode layers are kept physically apart from one another by means of separator layers. The separator layers consist of ion-conducting films. In addition to their function as ion conductors, they undertake mechanical supporting functions within the structure of the battery. In the present example, a cathode layer 5.1, 5.2, 5.3, . . . is respectively welded between two separator layers.

In the example shown, the output conductor pin has an outside diameter of 0.7 mm. The portions B, C and D are shown once again in greater detail in the following FIGS. 2A, 2B and 2C.

FIG. 2A schematically illustrates the contacting of the cathode layers 5.1, 5.2, 5.3, . . . of FIG. 2. These electrode layers contact the output conductor pin 4. Provided at their ends facing the output conductor pin are tabs 5.11, 5.21, 5.31, which altogether extend so far in their extent that they are displaced by the output conductor pin 4. Consequently, a mechanical pretensioning is produced between the cathode layers 5 and the output conductor pin 4. In this case, the coated part of the cathodes 5 is kept at a further distance from the output conductor pin. Only the carrier material is formed as a tab and lengthening of the electrode layer. Altogether, in the present example the coated part is kept at a distance of 0.53 mm from the output conductor pin. There is consequently an offset, that is to say a distance, between the coated part of the cathode 5 and the coated part of the anodes of 0.3 mm. The anodes themselves are likewise kept at a distance from the output conductor pin, to be specific with their coated part by 0.23 mm.

FIG. 2B illustrates the physical contacting of the anode layers with the housing part 2 of FIG. 2. The separator layers 8.1, 8.2, 8.3 . . . , which substantially surround the cathode layers, can likewise be seen well from this figure. These ends of the separator layers 8 are welded.

The anode layers 6.1, 6.2, 6.3, . . . are also kept at a distance from their output conductor, the housing part 2. In the present case, the distance Y2 is 0.1 mm. The distance of the separator layers Z from the housing inner wall of the housing part 2 is 0.05 mm. Formed on the anode layers 6.1, 6.2, . . . are tabs 6.1.1, 6.2.1, . . . , which ensure the physical contacting of the housing inner wall 17 of the housing part 2 and guarantee a mechanical pretensioning between these parts.

In the present example, the anode layers 6.1, 6.2, . . . comprise a copper carrier, which is coated on both sides. A single-sided coating would also be suitable, however, for carrying out the teaching according to the invention. In the present example, the cathode layer 5.1, 5.2, 5.3, . . . shown by way of example is an aluminum carrier that is coated on both sides.

The spacings and offsets between the electrode layers of opposite polarity minimize the risk of dendrite formation, and consequently of short-circuits.

In FIG. 2C, the weld seam 13 between the housing cover 9 and the housing part 2 is represented in detail. Altogether, the housing cover 9 has a thickness of 0.3 mm in the present example. A radial laser welding may be used for the welding of the housing cover 9 and the housing part 2. By this welding process, the housing part 2 is welded to the housing cover 9 in a gastight manner.

FIG. 3A shows a preassembled housing cover 9 with the output conductor pin 4 already connected by means of the sealing ring 7. However, in the present case the output conductor lugs 15 of the output conductor pin 4 are not yet bent. The output conductor lugs 14.1, 14.2, which are attached to the housing cover and in the assembled state serve as output conductors of the housing part 2, can likewise be seen. A flange 10, formed on the output conductor pin, arrests the output conductor pin against a correspondingly formed shoulder of the housing cover 9, and thereby improves the sealing.

The element shown in FIG. 3A is inserted as a preassembled part into the element shown in FIG. 3B. A housing part 2 in which a polypropylene nonwoven material 16 has been placed onto the housing base 11 can be seen in FIG. 3B. In addition to the nonwoven, an additional insulating film may be introduced. Subsequently, anodes 6.1, 6.2, 6.3 . . . and the cathodes 5.1, 5.2, 5.3, . . . welded into separators are placed in alternately. The tabs of greater diameter d of the anodes are pretensioned against the inner wall of the housing part 2 for good contacting. Thanks to the separator welding, the cathodes are mechanically stable and are centered on the inner wall of the housing part 2, so that a common clearance for receiving the output conductor pin is obtained at the center.

The corresponding electrolyte may be filled into this clearance in a glove box or a dry space. The electrolyte can subsequently distribute itself into the active components during an impregnating time. The cathodes have been welded in a previous working step. For this purpose, cathodes were respectively placed between two prepunched separator bands and partially welded at the periphery and then punched out or cut out. It has proven to be advantageous overall to cut out the cathodes and anodes from coated bands with a laser. The corresponding ablated areas, that is to say the parts that are not coated, can likewise be ablated by means of a laser. The use of a laser has advantages, in particular in terms of the precision of the production of the corresponding cathodes and anodes.

The preassembled element from FIG. 3A is subsequently inserted into the clearance in the electrode layers from FIG. 3B in such a way that the output conductor pin 4 extends through the entire interior volume 3 of the housing part 2. In the housing base of the housing part 2 there is an annular depression 12, which serves for the exact centering of the output conductor pin 4. However, precise positioning is also easily possible without this feature. In the present example, the housing base is concavely pretensioned. This produces a mechanical pretensioning of the output conductor pin 4 with respect to the housing cover 9 by way of the flange 10 and the corresponding sealing ring 7. With this mechanical pretensioning, a long-term sealing of the electrochemical cell is ensured with a minimal space requirement.

The closure of the battery may likewise take place in the glove box or in the dry space. During the insertion of the output conductor pin, the tabs of the cathode layers were mechanically pretensioned. The final gastight welding of the housing cover 9 to the housing part 2 takes place by a radial laser welding.

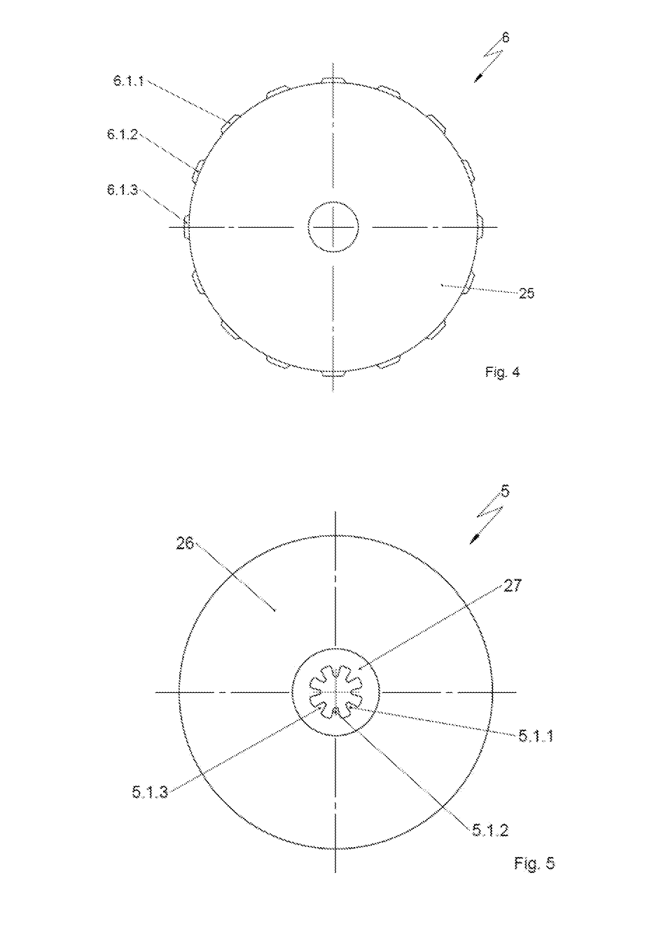

The tabs may be formed in one piece on the entire periphery of the electrode layers that contact the respective output conductor. Alternatively, however, the tabs may also be formed as individual tabs. For this purpose, FIG. 4 shows by way of example an anode layer with a coated part 25 and tabs 6.1, 6.1.2, 6.1.3, . . . consisting of the carrier material and protruding from this coated part 25. During assembly, these tabs are already sufficient to ensure a sufficient mechanical pretensioning. In the present example, sixteen of such tabs are shown.

Alternatively, the tabs may be formed as a single, continuous circular ring, encompassing the entire corresponding periphery. In principle, even two tabs are already sufficient to ensure a sufficient mechanical pretensioning.

In FIG. 5, an analogous example with a cathode layer 5 is shown. In this example, the cathode layer contacts the output conductor pin. For this reason, the non-coated part 27 is arranged at the center, on the inner periphery around the clearance. The non-coated part 27 can in turn be subdivided further into everted tabs 5.1.1, 5.1.2, 5.1.3. Also in this example, the number of tabs, that is to say eight, is merely given by way of example and is determined by the overall size and the arrangement of the battery. The carrier material is made of aluminum.

In this example, the divisions into cathode and anode and their respective contacting have been shown merely as examples, and even a converse arrangement, with the anode contacting the output conductor pin and the cathode contacting the housing part, is similarly conceivable without any disadvantages.

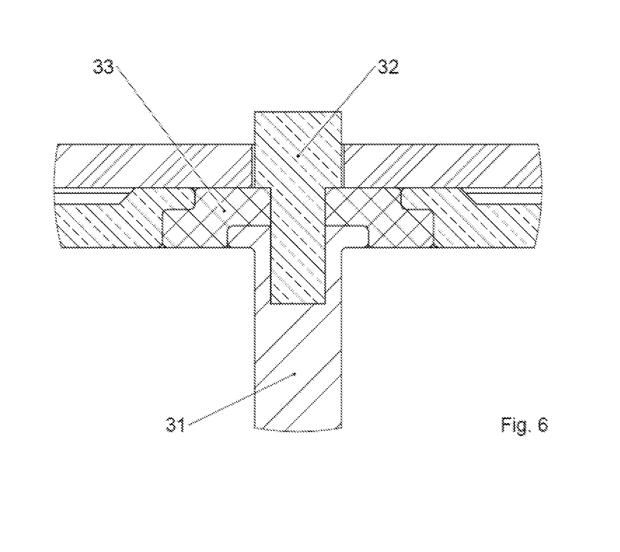

In FIG. 6, a particular embodiment is represented, one in which the pin is designed in two parts. In the example shown, the pin comprises a first material, which extends into the interior volume of the cell and consists of the same material as the contacted carrier material, in the present example aluminum, and also a second material, which was pressed together with the first material in a form-fitting manner in a preassembly step and consists of gilded copper. The second material is solderable.

The present invention provides an electrochemical cell that is suitable for long-term applications. It is particularly suitable for batteries with particularly small overall heights from 1.5 mm. An electrochemical cell of the lithium-ion type is shown by way of example in the figures and the detailed description. This example is merely shown for detailed illustration, and alternative ion types or elements may be used without departing from the essence of the invention.

1. Electrochemical cell, in particular a button cell, of a layered electrode structure, oppositely poled electrode layers being arranged such that they are physically separated from one another by separator layers, the cell also comprising:
a) a first housing part, which defines an interior volume and is designed in such a way that at the same time it forms an output conductor for a first electrode pole;
b) a pin, which extends from the outside into the interior volume and is designed in such a way that it forms an output conductor for a second electrode pole;
c) an insulation, which insulates the first housing part electrically from the pin, and
the cell being characterized in that
the electrode layers in the interior volume are in physical contact with their corresponding output conductors in such a way that there is a mechanical tensioning between the electrode layers and the corresponding output conductor.

2. Electrochemical cell according to claim 1, tabs, which protrude beyond the areal extent of the interior volume, in particular protrude in the direction of the respective output conductor, being formed on the electrode layers.

3. Electrochemical cell according to claim 1, the electrode layers comprising an anode and a cathode, which are each connected in a contact-bonded manner to an output conductor.

4. Electrochemical cell according to claim 1, the areal extent of the interior volume comprising an inside diameter D of the cell, and a first electrode layer being in physical contact with the first housing part as an output conductor and said electrode layer having an outside diameter D_{L}, which is greater than the inside diameter D by between 0.02 and 1.5 mm.

5. Electrochemical cell according to claim 4, the electrode layer having a second diameter D_{B}, which is smaller than the inside diameter D by between 0.05 and 0.5 mm.

6. Electrochemical cell according to claim 1, the pin being designed as a central output conductor shaft and designed in such a way that it extends through clearances in all the electrode layers of the entire interior volume.

7. Electrochemical cell according to claim 1, a first electrode layer comprising a first clearance, through which the pin extends, and the first clearance having a first diameter, in particular the first clearance having a first diameter that is greater than the outside diameter of the pin by between 0.2 and 1.6 mm.

8. Electrochemical cell according to claim 1, a second electrode layer being in physical contact with the pin as an output conductor and said second electrode layer comprising a second clearance, through which the pin extends, and the second clearance having a second diameter, in particular the second clearance having a second diameter that is smaller than the outside diameter of the pin by between 0.025 and 3 mm.

9. Electrochemical cell according to claim 8, a difference between the diameter of the second clearance and the pin having the effect of forming on the second electrode layer a tab by which the second electrode layer has an electrically conducting contact with the pin.

10. Electrochemical cell according to claim 1, an electrode layer being substantially enclosed by a separator layer, in particular a cathode layer being arranged between two separator layers welded to one another, more particularly two separator layers just on one tab for the physical contacting of the output conductor of the opposite side being welded to one another in such a way that they substantially surround an electrode layer.

11. Electrochemical cell according to claim 1, the electrode layers being arranged in the housing part in such a way that they have a mechanical pretensioning with respect to their respective output conductor.

12. Electrochemical cell according to claim 1, also comprising:
d) a housing cover with a clearance for receiving the pin, so that the latter can extend from the outside into the interior volume of the electrochemical cell, and
e) at least one seal between the housing part and the housing cover and/or the housing cover and the pin, which seal seals the electrochemical cell from the outside.

13. Electrochemical cell according to claim 12, the pin comprising a flange and the clearance in the housing cover being designed in such a way that there is a form fit between the flange of the pin and the housing cover.

14. Electrochemical cell according to claim 12, a housing base of the housing part that is arranged opposite from the housing cover being of a concave form.

15. Electrochemical cell according to claim 1, also comprising:
f) a nonwoven material for maintaining a mechanical pretensioning in the interior volume of the electrochemical cell, and in particular for insulating the electrode layers with respect to a housing base of the electrochemical cell.

16. Electrochemical cell according to claim 1, output conductor lugs, which are formed from solderable material, being provided on an outer side of the cell.

17. Method for producing an electrochemical cell, in particular an electrochemical cell according to claim 1, comprising the steps of:
a) alternately placing oppositely poled electrode layers in a first housing part, which defines an interior volume of the electrochemical cell;
b) pretensioning a first electrode layer with regard to the inner wall of the first housing part, by the diameter of this electrode layer being greater than the inside diameter of the first housing part;
c) filling with an electrolyte medium;
d) closing the electrochemical cell with a housing cover, a pin extending through the housing cover into the interior volume of the electrochemical cell in such a way that a pretensioning is produced between this pin and a second electrode layer, in particular in that the latter has a clearance for receiving the pin, the diameter of which is smaller than the outside diameter of the pin.

18. Method for producing an electrochemical cell according to claim 17, tabs being formed on the electrode layers for pretensioning the electrode layers with regard to their respective output conductor according to steps b) and d).

19. Method according to claim 17, the electrode layers being formed by cathode layers and anode layers and a cathode layer and/or anode layer being previously placed between two separator layers and the separator layers being connected in a material-bonded manner, in particular welded, at at least one location, in particular at a plurality of locations.

20. Method according to claim 17, also comprising the following step: preassembly of the housing cover and the pin, in that a sealing ring coated with a sealing compound is pressed in at a clearance in the housing cover and the pin is led through the clearance, so that it is pressed with a flange against the sealing ring.

21. Method according to claim 17, also comprising the step of: placing a nonwoven material in the first housing part.

22. Use of an electrochemical cell according to claim 1 as a battery in a hearing aid, the electrochemical cell being mounted directly on a circuit board.

23. Use of an electrochemical cell according to claim 1 as a battery in an implant, in particular a cardiac pacemaker.

24. Circuit board, comprising at least one cell according to claim 1 as an energy source.
